(19) United States
(12) Patent Application Publication
(10) Pub. No.: US 2025/0044163 A1
(43) Pub. Date: Feb. 6, 2025

(54) SENSOR FOR MEASUREMENTS OF THERMAL PROPERTIES AND METHOD OF MANUFACTURING THE SAME

(71) Applicant: Thermtest Inc., Hanwell (CA)

(72) Inventor: Dale HUME, Fredericton (CA)

(21) Appl. No.: 18/792,348

(22) Filed: Aug. 1, 2024

Related U.S. Application Data
(60) Provisional application No. 63/530,350, filed on Aug. 2, 2023.

(51) Int. Cl. G01K 1/08

(52) U.S. Cl. CPC G01K 1/08

(57) ABSTRACT

A sensor for measurements of thermal properties of a sample material is disclosed, comprising: a casing comprising two layers joined together, wherein respective layers of the two layers of the casing comprise ribbon ceramic or thin glass; and a heating element provided between the two layers. A method of manufacturing the sensor is also disclosed.

### CROSS-REFERENCE TO RELATED APPLICATIONS

This application claims priority to U.S. Provisional Patent Application No. 63/530,350, filed on Aug. 2, 2023, the entire contents of which is incorporated herein by reference for all purposes.

### TECHNICAL FIELD

The present disclosure relates to a sensor for measuring thermal properties of sample materials and a method of manufacturing a sensor for measuring thermal properties of sample materials.

### BACKGROUND

Measurement of thermal properties of a sample material with transient methods use a sensor typically composed of a casing around a heating element. The heating element also works as the sensing element. Relevant methods of measuring thermal properties of a sample material using such sensors include transient plane/disk source, transient strip source, modified transient plane source, etc.

Currently, sensors used in these measurement methods comprise a casing that is two films joined with glue/adhesive. The metal heating element gets placed/deposited/put onto the adhesive on one film, and then the other film with adhesive is put on top and pressed together with the film and heating element. To go to high temperature (e.g. 1000° C.), current casings are made of mica and stuck together with an adhesive. However, this construction makes the casing much thicker than a low (e.g. up to 300-400° C.) temperature sensor. Further, going to high temperatures (e.g. 700+° C.) will also melt the glue/adhesive and so the current high-temperature sensors are single use.

Accordingly, an additional, alternative, and/or improved sensor for measuring thermal properties of sample materials and a method of manufacturing the same remains highly desirable.

### SUMMARY

In accordance with one aspect of the present disclosure, a sensor for measuring thermal properties of a sample material is disclosed, comprising a casing comprising two layers joined together, wherein respective layers of the two layers of the casing comprise ribbon ceramic or thin glass; and a heating element provided between the two layers.

In some aspects, the ribbon ceramic comprises alumina ribbon ceramic or zirconia ribbon ceramic.

In some aspects, the heating element is deposited onto an inner surface of a first layer of the two layers of the casing by sputtering a metallic seed layer and electro-plating a conductor onto the metallic seed layer.

In some aspects, the metallic seed layer is titanium and the conductor is nickel.

In some aspects, an inner surface of a first layer of the two layers of the casing is covered with an adhesive, and the heating element is placed on the adhesive.

In some aspects, the heating element comprises nickel placed on the adhesive.

In some aspects, an inner surface of a second layer of the two layers of the casing is covered with the adhesive and joined to the first layer and the heating element.

In some aspects, the two layers are fused together using a laser.

In some aspects, the respective layers of ribbon ceramic or thin glass are each less than 100 micrometers thick.

In some aspects, the respective layers each comprise ribbon ceramic.

In some aspects, the respective layers each comprise thin glass.

In some aspects, the respective layers comprise a first layer comprising ribbon ceramic and a second layer comprising thin glass.

In accordance with another aspect of the present disclosure, a method of manufacturing a sensor for measurements of thermal properties of a sample material is disclosed, comprising: providing a heating element between two layers to be joined together, wherein respective layers of the two layers comprise ribbon ceramic or thin glass; and joining the two layers to form a casing surrounding the heating element.

In some aspects, joining the two layers to form the casing comprises fusing the two layers together using a laser.

In some aspects, the ribbon ceramic comprises alumina ribbon ceramic or zirconia ribbon ceramic.

In some aspects: the respective layers each comprise ribbon ceramic; the respective layers each comprise thin glass; or the respective layers comprise a first layer comprising ribbon ceramic and a second layer comprising thin glass.

In some aspects, providing the heating element between the two layers to be joined together comprises depositing the heating element on an inner surface of a first layer by sputtering a metallic seed layer and electro-plating a conductor onto the metallic seed layer.

In some aspects, providing the heating element between the two layers comprises covering an inner surface of a first layer with an adhesive, and placing the heating element on the adhesive.

In some aspects, the method further comprises covering an inner surface of a second layer with the adhesive, before joining the first and second layers.

In some aspects, the respective layers of ribbon ceramic or thin glass are each less than 100 micrometers thick.

### BRIEF DESCRIPTION OF THE DRAWINGS

Further features and advantages of the present disclosure will become apparent from the following detailed description, taken in combination with the appended drawings, in which:

FIG. 1 shows an exploded representation of a sensor for measuring thermal properties of a sample material in accordance with the present disclosure; and

FIG. 2 shows a method of manufacturing a sensor for measuring thermal properties of a sample material in accordance with the present disclosure.

It will be noted that throughout the appended drawings, like features are identified by like reference numerals.

### DETAILED DESCRIPTION

As described above, for high temperature thermal property measurement applications, the existing sensor technology uses mica as the casing for the sensor. The mica sensors have two mica layers, each of approximately 40 micrometers, with thermal properties that are highly anisotropic (the thermal conductivity of mica is much larger in the planar direction than the through-thickness/axial direction due to how mica is made). Mica has a conductivity of ˜1 W/mK in the axial direction, an axial diffusivity of ˜0.5 mm\hat{ }2/s, and a volumetric heat capacity (VHC) of ˜2MJ/m\hat{ }3K.

The ideal sensor for the transient plane source method would be infinitely thin and not have any heat capacity. This is not possible. The goal is to then minimize a) how long heat takes to travel through the sensor and b) to minimize how much heat the sensor absorbs during the measurement. The second point (heat absorbed) is much easier to correct for, and so the first point is more critical. Thermal diffusivity is used to calculate how far heat has travelled through a material within a given time, depth=sqrt (diffusivity*time). Higher diffusivity means greater depth, which means that the heat travelled faster.

Mica is primarily used in sensors for high temperature measurements, while sensors using a casing made of Kapton™ are the norm for temperatures up to 300-400 degrees Celsius. However, Kapton™ will deform (shrink/shrivel) at high temperature. As the Kapton deforms, at best the electrical trace of the heating element will similarly deform, and at worst the electrical trace will come in contact with itself or the sample, or the sensor will tear. Regardless, both possibilities are very bad for the accuracy and repeatability of the measurement (particularly as different sensors may deform differently, which is fairly random). Accordingly, Kapton™ is not used at temperatures greater than 300-400 degrees Celsius. The mica casing works at higher temperatures because even though the adhesive will fail, the mica will not and thus will prevent the heating element from touching the sample. However, as soon as the setup is taken apart (e.g. after the measurements on that sample are taken and it has been allowed to cool) the sensor will come apart or it will have cooled in a non-ideal fashion, making one part of the sensor much thicker, curved, or otherwise non-ideal. Accordingly, sensors having a casing made of mica can be used for high-temperature measurements, but they are generally single-use sensors.

In accordance with the present disclosure, a thermal measurement sensor is constructed with a casing made of ribbon ceramics (e.g. alumina or zirconia ribbons) and/or thin glass. Ribbon ceramics are thin (i.e. less than 100 micrometers) ribbons made of ceramic. Thin glass is glass that is likewise thin (i.e. less than 100 micrometers). Alumina or zirconia ribbon ceramic in particular is thin, slightly bendable, electrically insulative, capable of going to high temperature, and easy to work with. These qualities make it a very suitable as a casing for a transient plane source sensor. Additionally, ribbon ceramics are thermally conductive and diffusive (for example, alumina ribbon ceramic measured to be ˜36 W/mK in conductivity and ˜8 mm\hat{ }2/s in diffusivity, for a volumetric heat capacity of 4.5MJ/m\hat{ }3K). The thermal diffusivity of thin glass is on the order of 0.5-2 mm\hat{ }2/s. These ribbon ceramic and thin glass materials thus have a higher thermal diffusivity compared to mica, and thus are a better material for performing thermal measurements. Additionally, mica is a material comprised of small glass shards glued together, and so one contiguous ceramic or glass may be easier to treat mathematically or through simulation.

Moreover, ribbon ceramics and thin glass layers can be fused together using a laser. Further, the heating element can be deposited via a combination of sputtering and electro-plating onto a layer of ribbon ceramic or thin glass, thus avoiding the need to use an adhesive. This is not possible with mica, where the mica films must be covered with an adhesive that serves as the base for depositing the heating element. In contrast, a sensor with a ribbon ceramic or thin glass casing can be made without adhesive, resulting in a more ideal sensor. That is, two layers of ribbon ceramic and/or thin glass can be fused together around the heating element and could then be used in a high temperature measurement and return to ambient temperature without falling apart, carbonizing, or changing in any significant fashion. Accordingly, the sensor in accordance with the present disclosure provides a reusable high temperature sensor. Alternatively, the sensor can also be made with any technique the mica uses (including the use of adhesives), if desired. Another option of joining the layers of the casing together is using glass frits, which when melted act like glue to join the layers together. Glass frits are not used when manufacturing mica sensors as mica is a layered structure and therefore the frits may be attached only locally and the structural integrity of the sensor diminished.

A sensor having a casing made of ribbon ceramic and/or thin glass can also be used at lower temperatures instead of the commonly used Kapton™ sensors. However, Kapton™ sensors can generally be made relatively thin, so there may be less benefit to using ribbon ceramic and/or thin glass sensors at lower temperatures.

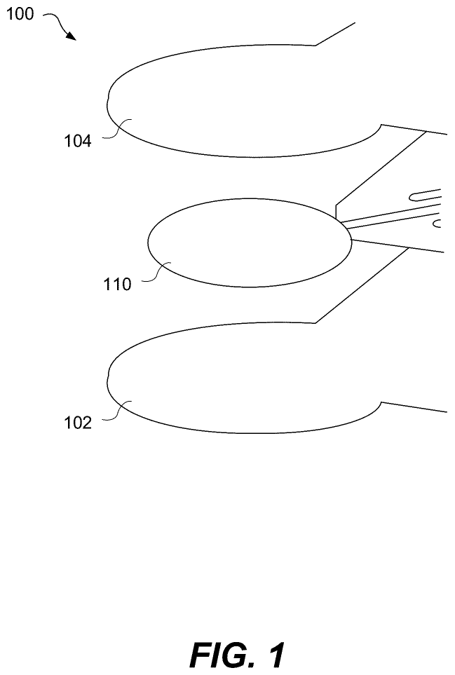

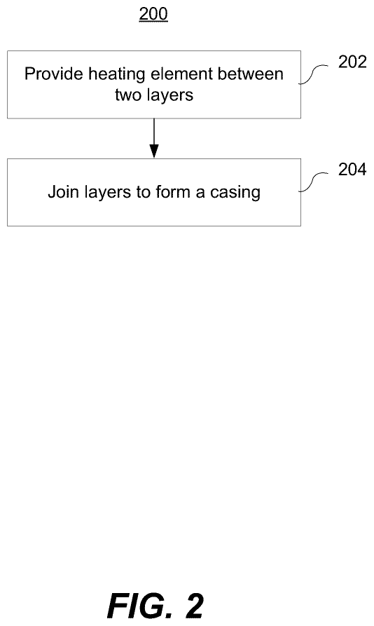

Embodiments are described below, by way of example only, with reference to FIGS. 1 and 2.

FIG. 1 shows an exploded representation of a sensor for measuring thermal properties of a sample material in accordance with the present disclosure.

The sensor 100 comprises a casing having first and second casing elements comprising a first layer 102 and a second layer 104. The first layer 102 and second layer 104 are joined together, directly or indirectly. In accordance with the present disclosure, the first and second layers of the sensor are made of a ribbon ceramic and/or thin glass. That is, respective layers of the first and second layers may be made of ribbon ceramic or thin glass. In some embodiments, both layers are made of ribbon ceramic. In other embodiments, both layers are made of thin glass. In still other embodiments, one layer is made of ribbon ceramic, and the other layer is made of thin glass. The ribbon ceramic layers may comprise alumina ribbon ceramic or zirconia ribbon ceramic. Symmetry in the principles of measurement dictate that the first and second layers should be the same material, but they could in theory be different (e.g. if one layer bonds to the heat source better, and the other is much thinner). The ribbon ceramic layers or thin glass layers are each less than 100 micrometers thick.

An electrically conductive heating element 110 is provided between the two layers, and in particular may be provided on an inner surface of one of the two layers. The first and second layers and the electrically conductive heating element can be joined together in various fashions. For example, the first and second layers of ribbon ceramic or thin glass can be fused together via a laser. The heating element 110 may be deposited or adhered onto one of the first and second layers. The heating element 110 should have exposed points where it can be connected to a power source and measurement instrument. The heating element can have any pattern, but as appreciated by a person skilled in the art some patterns of the electrical trace providing the heating element are better than others. The heating element can generally be made from any conductor with a temperature coefficient of resistance that is not zero at any point in the intended temperature range of operation. In some embodiments, the heating element may be made of nickel.

In use, the sensor 100 is inserted into a sample material for measuring thermal properties of the material. The sensor 100 acts as both a heating and a heat-sensing item. The electrically conductive heating element 110 is configured to conduct electricity, which heats up the sensor and the surrounding sample material. The resistance of the electrically conductive heating element 110 is related to the temperature of the surrounding sample material. As described above, a casing of the sensor made of two layers of ribbon ceramics or thin glass result in a thin casing having a high thermal diffusivity, thus improving the accuracy of measurements taken by the sensor. Resistance recordings are taken during a measurement period for recording the time dependent temperature increase of the sample material. Electricity through the electrically conductive heating element is provided via electrical leads, and is controlled by a controller (not shown).

FIG. 2 shows a method 200 of manufacturing a sensor for measuring thermal properties of a sample material in accordance with the present disclosure.

The method 200 comprises providing a heating element between two layers to be joined together (202), wherein respective layers of the two layers comprise ribbon ceramic or thin glass. In some embodiments, providing the heating element between the two layers to be joined together comprises depositing the heating element on an inner surface of a first layer by sputtering a metallic seed layer and electro-plating a conductor onto the metallic seed layer. For example, titanium may be sputtered onto the first ribbon ceramic layer, and nickel may be electro-pated onto the titanium. In an alternative embodiment, providing the heating element between the two layers to be joined together comprises covering an inner surface of a first layer with an adhesive (e.g. liquid or film), and placing the heating element on the adhesive via lamination.

The method 200 further comprises joining the two layers to form a casing surrounding the heating element (204). For example, the first and second layers may be joined by laser fusing. Where the heating element is adhered to the first layer, the method may further comprise covering an inner surface of the second layer with the adhesive, before joining the first and second layers.

Two example sensors in accordance with the present disclosure are described below. These examples are embodiments of the present disclosure, however it will be appreciated that different construction of sensors can be made in accordance with the present disclosure.

(1) A sensor comprising a casing made from thin glass layers with titanium sputtered onto one or both of the layers in a pattern (e.g. double spiral) connected to wide leads (so that the sensor won't have its connections right next to the spiral, the sample getting tested has to go on top and below the spiral section of the sensor). Nickel gets electro-plated onto the titanium to such a thickness that the titanium is negligible in comparison. A second thin glass layer is pressed on top of this, and then the two thin glass layers are laser fused together. The second layer would have holes over the leads so that the sensor can be connected to electronics.

(2) A sensor made from alumina or zirconia ribbon ceramic layers. One side (i.e. the inner surface) of a first ribbon ceramic layer gets covered with an adhesive. Nickel gets placed on the adhesive via lamination in the same pattern as above. Adhesive is covered onto the inner surface of a second ribbon ceramic layer, and this second ribbon ceramic layer having adhesive but no nickel gets placed on top of the first ribbon ceramic layer. The casing of the sensor will be joined together.

The first example sensor (without adhesive) provides for a reusable high-temperature sensor. While the second example sensor described above with adhesive would suffer from the same single-use-ness of mica sensors, it would still allow for improved measurements due to its thin design and higher thermal diffusivity. Accordingly both examples of sensors provide improvements over existing mica sensors for high temperature measurements.

It would be appreciated by one of ordinary skill in the art that the system and components shown in the figures may include components not shown in the drawings. For simplicity and clarity of the illustration, elements in the figures are not necessarily to scale, are only schematic and are non-limiting of the element structures. It will be apparent to persons skilled in the art that a number of variations and modifications can be made without departing from the scope of the invention as described herein.

It is contemplated that any part of any aspect or embodiment discussed in this specification can be implemented or combined with any part of any other aspect or embodiment discussed in this specification.

It should be recognized that features and aspects of the various examples provided above can be combined into further examples that also fall within the scope of the present disclosure.

When used in this specification and claims, the terms “comprises” and “comprising” and variations thereof mean that the specified features, steps, or components are included. The terms are not to be interpreted to exclude the presence of other features, steps, or components.

The invention may also broadly consist in the parts, elements, steps, examples and/or features referred to or indicated in the specification individually or collectively in any and all combinations of two or more said parts, elements, steps, examples, and/or features. In particular, one or more features in any of the embodiments described herein may be combined with one or more features from any other embodiment(s) described herein.

1. A sensor for measurements of thermal properties of a sample material, comprising:
a casing comprising two layers joined together, wherein respective layers of the two layers of the casing comprise ribbon ceramic or thin glass; and
a heating element provided between the two layers.

2. The sensor of claim 1, wherein the ribbon ceramic comprises alumina ribbon ceramic or zirconia ribbon ceramic.

3. The sensor of claim 1, wherein the heating element is deposited onto an inner surface of a first layer of the two layers of the casing by sputtering a metallic seed layer and electro-plating a conductor onto the metallic seed layer.

4. The sensor of claim 3, wherein the metallic seed layer is titanium and the conductor is nickel.

5. The sensor of claim 1, wherein an inner surface of a first layer of the two layers of the casing is covered with an adhesive, and the heating element is placed on the adhesive.

6. The sensor of claim 5, wherein the heating element comprises nickel placed on the adhesive.

7. The sensor of claim 5, wherein an inner surface of a second layer of the two layers of the casing is covered with the adhesive and joined to the first layer and the heating element.

8. The sensor of claim 1, wherein the two layers are fused together using a laser.

9. The sensor of claim 1, wherein the respective layers of ribbon ceramic or thin glass are each less than 100 micrometers thick.

10. The sensor of claim 1, wherein the respective layers each comprise ribbon ceramic.

11. The sensor of claim 1, wherein the respective layers each comprise thin glass.

12. The sensor of claim 1, wherein the respective layers comprise a first layer comprising ribbon ceramic and a second layer comprising thin glass.

13. A method of manufacturing a sensor for measurements of thermal properties of a sample material, comprising:
providing a heating element between two layers to be joined together, wherein respective layers of the two layers comprise ribbon ceramic or thin glass; and
joining the two layers to form a casing surrounding the heating element.

14. The method of claim 13, wherein joining the two layers to form the casing comprises fusing the two layers together using a laser.

15. The method of claim 13, wherein the ribbon ceramic comprises alumina ribbon ceramic or zirconia ribbon ceramic.

16. The method of claim 13, wherein:
the respective layers each comprise ribbon ceramic;
the respective layers each comprise thin glass; or
the respective layers comprise a first layer comprising ribbon ceramic and a second layer comprising thin glass.

17. The method of claim 13, wherein providing the heating element between the two layers to be joined together comprises depositing the heating element on an inner surface of a first layer by sputtering a metallic seed layer and electro-plating a conductor onto the metallic seed layer.

18. The method of claim 13, wherein providing the heating element between the two layers comprises covering an inner surface of a first layer with an adhesive, and placing the heating element on the adhesive.

19. The method of claim 18, further comprising covering an inner surface of a second layer with the adhesive, before joining the first and second layers.

20. The method of claim 13, wherein the respective layers of ribbon ceramic or thin glass are each less than 100 micrometers thick.
